(19) United States
(12) Patent Application Publication
(10) Pub. No.: US 2008/0135723 A1
(43) Pub. Date: Jun. 12, 2008

(54) Focal plane and method for adjusting a focal plane of this type

(75) Inventors: Anko Borner, Wildau (DE); Andreas Eckardt, Berlin (DE); Ingo Walter, Berlin (DE); Stefan Hilbert, Zeuthen (DE)

Correspondence Address: COHEN, PONTANI, LIEBERMAN & PAVANE, 551 FIFTH AVENUE, SUITE 1210, NEW YORK, NY, 10176, US

(73) Assignee: Deutsches Zentrum fur Luft-und Raumfahrt e.V., Koeln (DE)

(21) Appl. No.: 11/636,279

(22) Filed: Dec. 8, 2006

(51) Int. Cl. G02B 27/40

(52) U.S. Cl. 250/201.2

(57) ABSTRACT

A focal plane assembly for an optical sensor system, includes at least two photosensitive components and a focal plane plate, on which the photosensitive components are mounted. The focal plane plate is formed out of a number of modules, where the photosensitive components are distributed over the modules and connected to them, and where the individual modules are mounted in a common focal plane frame.

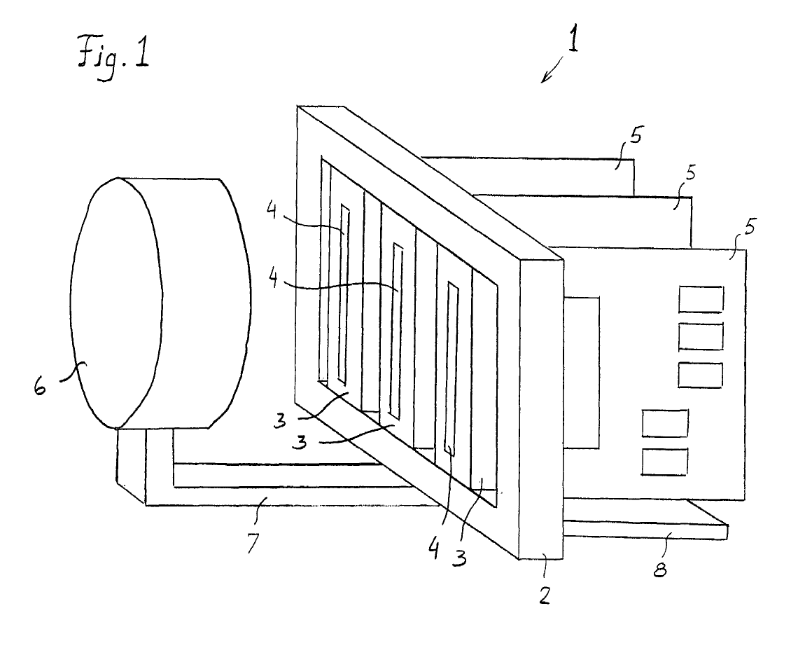

The invention pertains to a focal plane for an optical sensor system and to a method for adjusting a focal plane of this type.

High-resolution cameras with photosensitive semiconductor sensors are used to take aerial photos, for example, and are replacing conventional aircraft cameras using large-format film. The photosensitive semiconductor sensors are designed in the form of CCDs, for example. Very recently, so-called CMOS cameras have also been developed. These and similar sensors can in general be called “photosensitive semiconductor sensors”, where the problems of the CCD components described below also pertain as appropriate to these other types of photosensitive semiconductor sensors. In the case of a high-resolution CCD cameras, the CCD component, designed as a linear array or a matrix, is arranged in the film plane, i.e., the so-called focal plane, as a result of which the intermediate step of film development required for conventional film cameras is eliminated. The entire set of image data is available in digital form directly on line and in real time. Replacing the film of an aerial camera with a focal plane equipped with CCD components, however, leads to various difficulties.

The CCD components themselves and the electronics around these components consume electrical energy, which is converted to heat in the form of power dissipation. In addition, these systems must operate at a constant working temperature under conditions of widely varying ambient temperatures. These problems are currently being solved by building a special focal plane base plate consisting of a material which is compatible with the CCD chips of silicon in terms of thermal expansion and which is connected under certain conditions to a heat sink to keep the temperature of the focal plane constant. These focal plane hybrids are equipped with previously isolated and pretested chips.

As a result of widely varying sets of tolerances such as those for the chips, for the housings, for the focal plane base plate, and/or for the means of attaching the chips and the housings to the focal plane base plate, it is no longer guaranteed that all the pixels of the various chips will lie in the same plane.

DE 199 32 065 A1 describes a focal plane plate for a high-resolution camera with photosensitive sensors, the plate consisting of an electrically nonconductive material, on which the housings holding the photosensitive semiconductor sensors are mounted. Either adjusting elements are installed on the focal plane plate at the sites where the housings of the photosensitive semiconductor sensors are located, or the focal plane plate itself is designed with adjusting elements. These adjusting elements can be adapted mechanically to conform to the shape of the housing. The disadvantage of this known focal plane plate is that this mechanical adaptation is very expensive.

The invention is therefore based on the technical problem of creating a focal plane which allows the photosensitive components to be adjusted more easily with respect to each other and on the problem of making available an associated method.

The technical problem is solved by the objects with the features of claims 1 and 6. Additional advantageous embodiments of the invention can be derived from the subclaims.

To accomplish the goal, the focal plane plate is designed to consist of several modular parts, where the photosensitive components are distributed over the modules and are connected to them, the individual modules being mounted in a common focal plane frame. As a result, the individual photosensitive sensors with the modules assigned to them can be adjusted and calibrated individually with respect to the optical system, and the modules can then be attached permanently to the focal plane frame. With the proposed concept, the photosensitive sensors can be easily adapted to the specific boundary conditions defined by the optical components and/or specified by the user such as, for example, focal depth, stereo angle, and aberration. Thus aberrations of the optical components such as chromatic aberration, that is, the wavelength-dependent shift of the focal point, can also be corrected. If, for example, the sensors are operated as R, G, and B linear-array sensors, the individual linear array can be shifted along the optical axis until it is located exactly in the film plane for the color wavelength in question.

In a preferred embodiment, the focal plane frame is rigidly connected to an optical component of the optical sensor system. As a result, it is guaranteed that the adjustment and calibration will be implemented for the entire system and will not change as the result of a change in the installed positions of the optical components.

In another preferred embodiment, the modules are designed with a heat sink and/or are connected to a heat sink to carry away the dissipated electrical energy. The heat sink is designed, for example, as a heat-conducting tube.

In another preferred embodiment, exactly one photosensitive component is assigned to each module, so that this component can be adjusted and calibrated individually. Applications are also conceivable, however, in which two or more photosensitive components can be arranged together on one module. This can be true in cases where, for example, the components are not critical with respect to calibration or in cases where they behave in almost exactly the same way.

In another preferred embodiment, the modules can be made of different materials. As a result, it becomes possible to use different types of sensors, because the material of the module can be optimally adapted to the sensor in terms of, for example, its thermal expansion.

CCD or CMOS linear-array sensors but also TDI (Time Delay and Integration) or MCT (Mercury Cadmium Telluride) linear arrays can be used as the photosensitive sensors. Of course, matrix sensors or other forms can also be used in principle.

With respect to the method, the individual components are adjusted and calibrated and then fixed in place on the focal plane frame. The fixation is preferably achieved by means of permanently locking, rigid connections. The adjustments and calibrations are carried out preferably with the help of static and/or dynamic photomodulators. For this purpose, an evaluation and control unit, for example, projects sequences of images via the photomodulators onto the components. The evaluation and control unit then checks the results by reading out the data from the components. By means of a micromanipulator, the modules can then be shifted until correctly adjusted, and then they can be calibrated.

The invention is explained in greater detail below on the basis of a preferred exemplary embodiment. The single FIGURE shows a schematic diagram of a focal plane.

The focal plane 1 comprises a focal plane frame 2, three modules 3, three linear-array sensors 4 arranged on the modules 3, and an electronic drive and readout circuit 5 for each linear-array sensor 4. The linear-array sensors 4 are permanently connected to their assigned modules 3. The linear-array sensors 4 are also connected to their electronic drive and readout circuits 5; the sensors can be soldered to the circuits, or they can be connected by means of plug-and-socket connectors. The modules 3 themselves are supported in the focal plane frame 2 but initially have a certain freedom of movement. For example, the modules 3 can be bedded in a layer of liquid adhesive, so that they can still be moved in all three degrees of translational freedom before the adhesive cures. The focal plane frame 2 is rigidly connected to an optical component 6 by way of a suitable bracket (not shown).

For the adjustment, one or more test patterns are projected through the optical component 6 onto the first linear-array sensor 4. Then the electronic drive and readout circuit 5 reads out the data from the linear-array sensor 4. The results are used to determine any misalignment of the linear-array sensor 4, and a micromanipulator, for example, can be used to make the necessary corrections. Then the linear-array sensor 4 is calibrated geometrically, radiometrically, and/or spectrally. This procedure is repeated for each of the remaining modules 3. Finally, the adhesive is cured. Of course, it is also possible to cure the adhesive of one module 3 before going on to adjust the next module 3. As an alternative to an adhesive, the modules 3 could also be supported and moved by means of piezoelectric adjusting elements. After the adjustments are completed, the modules 3 would then be embedded in epoxy resin. The adjustments and calibrations are carried out preferably by means of static and/or dynamic photomodulators. Dynamic photomodulators can be driven by an evaluation and control unit to generate images with different specifications. Dynamic photomodulators can be designed as LCD matrices, as micromirror arrays, and/or as membrane mirrors. The evaluation and control unit is then preferably connected to the drive and readout circuits of the linear-array sensors.

1.-6. (canceled)

7. A focal plane assembly for an optical sensor system, comprising:
a focal plane frame;
a focal plane plate comprising a plurality of modules; and
at least two photosensitive components mounted on said focal plane plate, wherein said photosensitive components are distributed over said plurality of modules and respectively connected to said plurality of modules such that each module of said plurality of modules has a set of photosensitive components comprising at least one of said photosensitive components, and wherein said each module of said set of modules is separately mounted in said focal plane frame such that each of said sets of photosensitive components is calibrated by adjusting a position of the respective one of said modules relative to said focal plate.

8. The focal plane assembly of claim 7, further comprising an optical component of the optical sensor system, wherein said sensor focal plane frame is rigidly connected to said optical component.

9. The focal plane assembly of claim 1, further comprising a heat sink, wherein said modules include a heat sink or are connected to a heat sink.

10. The focal plane assembly of claim 1, wherein only a single photosensitive component is assigned to said each module of said plurality of modules.

11. The focal plane assembly of claim 1, wherein at least two modules of said plurality of modules are formed of different materials.

12. A method for adjusting a focal plane of a focal plane assembly comprising a focal plane frame, a focal plane plate comprising a set of modules, at least two photosensitive components mounted on the focal plane plate, wherein the photosensitive components are distributed over the set of modules and respectively connected to the set of modules so that each module of the set of modules includes at least one of the photosensitive components, and wherein the each module of the set of modules is separately mounted in said focal plane frame, said method comprising the steps of:
individually adjusting and calibrating the photosensitive components on respective individual modules of the set of modules including moving the respective individual module relative to the focal plane plate; and
fixing the respective individual modules in place on the focal plane frame after said step of adjusting and calibrating.
